(19) United States
(12) Patent Application Publication
(10) Pub. No.: US 2026/0284626 A1
(43) Pub. Date: Sep. 24, 2026

(54) CHEMICAL PROCESSING VESSELS THAT INCLUDE SUPPORT BEAMS AND METHODS OF USING THE SAME

(71) Applicant: Dow Global Technologies LLC, Midland, MI (US)

(72) Inventors: Matthew T. Pretz, Lake Jackson, TX (US); Albert Meza, Cypress, TX (US); Donald F. Shaw, Farked River, NJ (US); Richard E. Walter, Long Valley, NJ (US); Fermin Sandoval, Pearland, TX (US); Quan Yuan, Sugarland, TX (US)

(73) Assignee: Dow Global Technologies LLC, Midland, MI (US)

(21) Appl. No.: 19/476,451

(22) PCT Filed: Apr. 18, 2024
(86) PCT No.: PCT/US2024/025122

§ 371 Date: Oct. 17, 2025

Related U.S. Application Data
(60) Provisional application No. 63/497,312, filed on Apr. 20, 2023.

(51) Int. Cl. B01J 8/18; B01J 8/24

(52) U.S. Cl. CPC B01J 8/1872; B01J 8/24; B01J 2208/00884

(57) ABSTRACT

Disclosed herein are chemical processing vessels and methods for the use thereof. A chemical processing vessel may include side walls defining a main interior space, an internal structure positioned within the main interior space, and a support beam positioned within the main interior space and including a substantially vertical height dimension and a substantially horizontal length dimension. Opposing ends of the support beam in the substantially horizontal length dimension may each be coupled to the side walls, the support beam may support the internal structure, and the support beam may also include a substantially vertical surface portion lying in a plane including the substantially vertical height dimension. The substantially vertical surface portion may include a plurality of openings through a width of the support beam defining an open area in the substantially vertical surface portion. The open area in the substantially vertical surface portion may include from 30% to 95% of the substantially vertical surface portion.

### CROSS-REFERENCE TO RELATED APPLICATIONS

This application claims the benefit of U.S. Provisional Application Ser. No. 63/497,312 filed Apr. 20, 2023, the contents of which are incorporated in their entirety herein.

### FIELD

The embodiments described herein generally relate to chemical processing and, more particularly, to equipment utilized in chemical processing.

### BACKGROUND

Fluidized bed reactors are widely used in various industrial applications for chemical reactions. They have been applied in areas such as petrochemical, chemical, and power production industries for over a century. In fluidized bed reactors, a fluid such as air or another gas is passed through a bed of solid particles, which are suspended and made to behave like a fluid by the flow of the fluidizing medium. Due to their prominence in industry, improved fluidized bed reactors are desired.

### SUMMARY

As described herein, some chemical processing vessels, such as those that operate as fluidized bed reactors, include mechanical internals. For example, a wide variety of internal structures (sometimes referred to simply as “internals” in industry) are utilized in various industrial vessels that act as fluidized bed reactors. These include, without limitation, gratings that help to normalize fluidized particulate flow by “bubble-breaking.” Such internal structures may be relatively heavy, and may need to be mechanically supported by support beams (for example, I-beams). In relatively large processing vessels, where support beams may be relatively large, it has been presently discovered that the support beams may hinder radial mixing of fluidized particles, such as particulate solid catalysts, and negatively affect the gas/solid contact regime. Disclosed herein are support beams that include a plurality of openings. According to embodiments, the fluidized particles may be able to pass through the openings, which may mitigate the radial mal-mixing caused by the presence of the support beams.

According to one or more embodiments of the present disclosure, a chemical processing vessel may include side walls defining a main interior space, an internal structure positioned within the main interior space, and a support beam positioned within the main interior space that may include a substantially vertical height dimension and a substantially horizontal length dimension. Opposing ends of the support beam in the substantially horizontal length dimension may each be positioned at or near the side walls and the support beam may support the internal structure. The support beam may include a substantially vertical surface portion lying in a plane including the substantially vertical height dimension. The substantially vertical surface portion may include a plurality of openings through a width of the support beam defining an open area in the substantially vertical surface portion and the open area in the substantially vertical surface portion may include from 30% to 95% of the substantially vertical surface portion.

According to one or more additional embodiments of the present disclosure, a method for chemical processing may include contacting a reactant with fluidized particles in a chemical processing vessel. The fluidized particles may be a fluidized bed flow regime. The chemical processing vessel may include side walls defining a main interior space, an internal structure positioned within the main interior space, and a support beam positioned within the main interior space that may include a substantially vertical height dimension and a substantially horizontal length dimension. Opposing ends of the support beam in the substantially horizontal length dimension may each be positioned at or near the side walls and the support beam may support the internal structure. The support beam may include a substantially vertical surface portion lying in a plane including the substantially vertical height dimension. The substantially vertical surface portion may include a plurality of openings through a width of the support beam defining an open area in the substantially vertical surface portion and the open area in the substantially vertical surface portion may include from 30% to 95% of the substantially vertical surface portion.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 depicts a front cross-sectional view of a chemical processing vessel, according to one or more embodiments illustrated and described herein;

FIG. 2A depicts an isometric view of an internal structure that includes a square second plurality of openings, according to one or more embodiments illustrated and described herein;

FIG. 2B depicts an isometric view of an internal structure that includes a diamond second plurality of openings, according to one or more embodiments illustrated and described herein;

FIG. 3 depicts a side cross-sectional view of the chemical processing vessel of FIG. 1, according to one or more embodiments illustrated and described herein; and

FIG. 4 depicts a support beam, according to one or more embodiments illustrated and described herein.

It should be understood that the drawings are schematic in nature, and do not include some components of a fluid catalytic reactor system commonly employed in the art, such as, without limitation, temperature transmitters, pressure transmitters, flow meters, pumps, valves, and the like. It would be known that these components are within the spirit and scope of the present embodiments disclosed. However, operational components, such as those described in the present disclosure, may be added to the embodiments described in this disclosure.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

Embodiments described herein are generally directed to chemical processing vessels and methods for their use. The chemical processing vessels described herein include support beams which act to support internal structures such as, for example, gratings. As described herein, the support beams include opening through which gases and fluidized particles may pass while the chemical processing vessel operates under a fluidized bed flow regime.

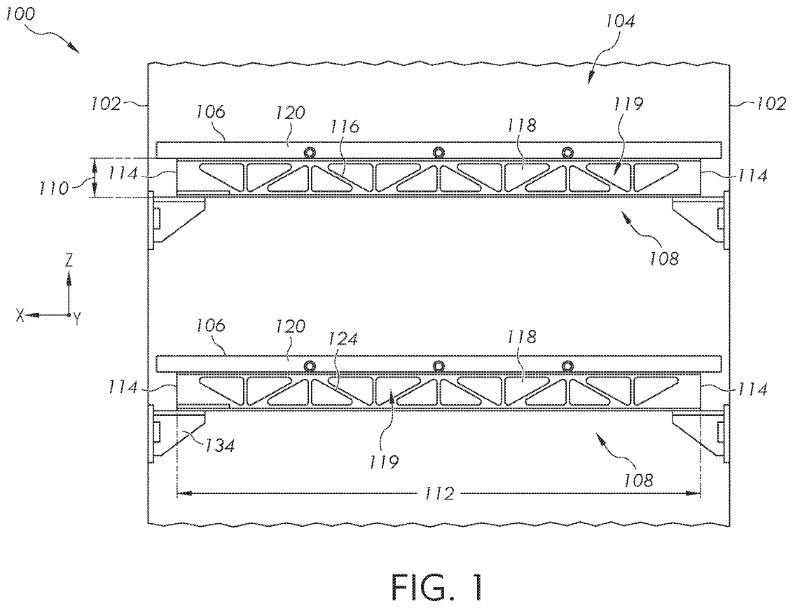

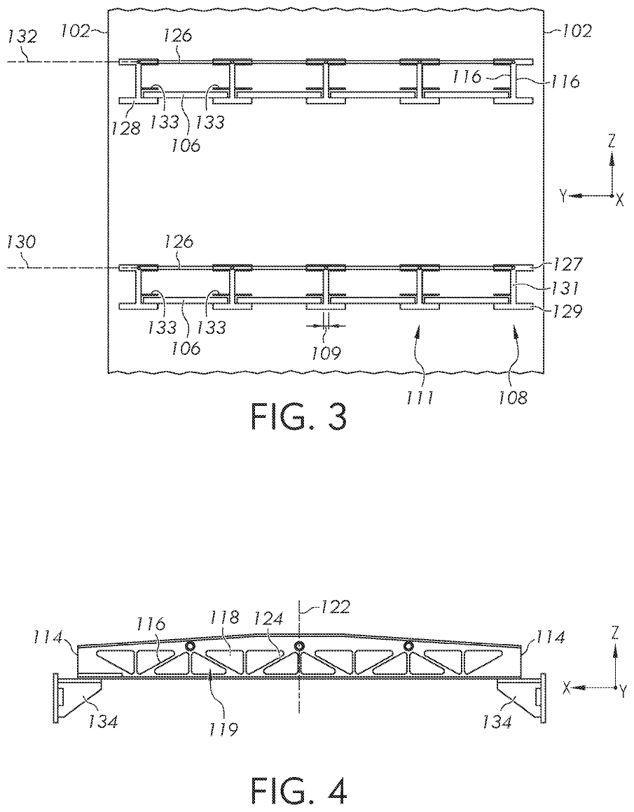

Now referring to FIG. 1, one embodiment of a chemical processing vessel 100 is schematically depicted in a cross-sectional view. FIG. 3 additionally depicts a cross-sectional view of the embodiment of FIG. 1 but from an angle perpendicular to that of FIG. 1. This embodiment is only one contemplated embodiment, and it should be understood that those skilled in the art may generalized the teachings with respect to FIG. 1, and various modifications and variations can be made to the described embodiments of FIG. 1.

The chemical processing vessel 100 of FIG. 1 includes side walls 102, and the side walls 102 define a main interior space 104. An internal structure 106 is positioned within the main interior space 104. A support beam 108 is also placed within the main interior space 104 and includes a substantially vertical height dimension 110 and a substantially horizontal length dimension 112. Opposing ends 114 of the support beam 108 in the substantially horizontal length dimension 112 are each coupled to the side walls 102. The support beam 108 supports the internal structure 106. The support beam 108 includes a substantially vertical surface portion 116 lying in a plane including the substantially vertical height dimension 110. The substantially vertical surface portion 116 includes a plurality of openings 118 through a width 109 of the support beam 108 defining an open area 119 in the substantially vertical surface portion 116. In one or more embodiments, the open area 119 in the substantially vertical surface portion 116 may comprise from 30% to 95% of the substantially vertical surface portion 116.

As described herein, it should be understood that “substantially vertical” and “substantially horizontal” are intended to include directions or planes that are not completely vertical or horizontal, such as directions or planes 1 degree, 2 degrees, 3 degrees, 4 degrees, or even 5 degrees off of horizontal or vertical.

The chemical processing vessel 100 includes the side walls 102 that define the main interior space 104. The side walls 102 making up the chemical processing vessel 100 may be side walls of a vessel, drum, barrel, vat, or any other container suitable for a given chemical reaction, such that the chemical processing vessel 100 may be any of these geometric configurations. As described in greater detail herein, the chemical processing vessel 100 may operate as a fluidized bed reactor. The side walls 102 may be made up of metal or any other suitable material for withstanding temperatures of up to, from example, 925° C. within the main interior space 104, an optionally may be coated with refractory materials for heat management. Various components may be positioned within the main interior space 104, as is described herein.

The internal structure 106 is positioned within the main interior space 104. While FIGS. 1 and 3 depict grating tray embodiments as the internal structure 106, the shape and size of the internal structure is not necessarily limited. Other internal structures may include distributors, liquid injectors, separators, other injection ports, or any other device that may be desired to be placed into a reactor for any purpose.

Referring again to FIG. 1, the internal structure 106, such as a grating tray 120 may substantially lie in the horizontal plane. The substantially horizontal plane is defined by the x-y axes of FIG. 1. The internal structure 106 may function to break up a plurality of fluidized gas bubbles flowing in a vertical direction defined by the z-axis by allowing for restricted passage of fluids. The internal structure 106 may function to redistribute a flow of the plurality of fluidized gas bubbles to prevent “short-circuiting” of the fluidized bed. The internal structure 106 may also reduce back-mixing of a catalyst emulsion phase and gases entrained in the catalyst emulsion phase. The internal structure may be made of metal or any other suitable material capable of withstanding reaction temperatures within the main interior space 104 of the chemical processing vessel 100. In some embodiments, a plurality of internal structures 106 are positioned along multiple vertical elevations along the z-axis; the plurality of the internal structures 106 may be spaced vertically with a distance of 2 feet to 6 feet apart. As such, there may be one, two, three four, or more layers of internal structures 106 positioned along multiple vertical elevations along the z-axis.

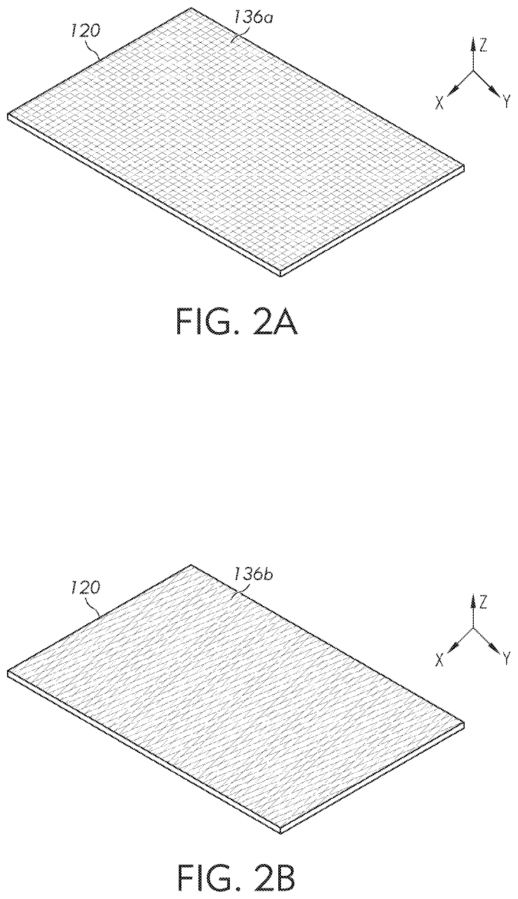

In one or more embodiments, the internal structure 106 may include a grating tray 120. Examples of grating trays 120 are depicted in FIGS. 2A and 2B, The grating tray 120 may include a second plurality of openings 136. The second plurality of openings 136 may be through a substantially horizontal surface portion of the grating tray 120 in the substantially horizontal plane, defined by the x-y axes of FIG. 2. The second plurality of openings 136 may include from 30% to 95% of the horizontal surface portion of the grating tray 120. The second plurality of openings 136 may make up a square, rectangular, hexagonal, honeycomb, or any other suitable pattern. As an exemplary embodiment, FIG. 2A depicts a square second plurality of openings 136a and FIG. 2B depicts a diamond second plurality of openings 136b. The second plurality of openings 136 may be from 0.5 inches to 10 inches in width or diameter, or from 1 inch to 4 inches in width or diameter, such that the second plurality of openings 136 are smaller in width or diameter than the plurality of fluidized gas bubbles; thus, the second plurality of openings 136 may break up the plurality of fluidized gas bubbles flowing in the vertical direction defined by the z-axis in FIG. 2. The internal structure 106, such as the grating tray 120, are supported by the support beam 108.

Referring again to FIG. 1, the support beam 108 is positioned within the main interior space 104 of the chemical processing vessel 100. The support beam 108 includes the substantially vertical height dimension 110 and the substantially horizontal length dimension 112. The substantially vertical height dimension 110 is along the z-axis of FIG. 1, while the substantially horizontal length dimension 112 is along the x-axis of FIG. 1. The substantially vertical height dimension 110 may be from 4 inches to 12 feet in height, or from 0.75 feet to 4 feet in height. The substantially horizontal length dimension 112 may be from 2 feet to 100 feet, or from 10 feet to 50 feet in length. The support beam 108 includes opposing ends 114 in the substantially horizontal length dimension 112.

The opposing ends 114 of the support beam 108 in the substantially horizontal length dimension 112 may be positioned at or near the side walls 102. For example, each opposing end 114 may be coupled to the side walls 102 via beam support chairs 134. As described herein, “coupling” of support beams 134 to the side walls 102 need not include direct contact between the support beams 134 and the side walls 102. For example, as shown in FIG. 1, beam support chairs 134, which may secure and/or support the support beam 134, may be directly coupled to the side walls 102 through welding, bolting, or any other suitable coupling means. As depicted in FIG. 1, the opposing ends 114 may be coupled to the side walls 102 through beam support chairs 134. The opposing ends 114 of the support beam 108 may rest on the beam support chairs 134. The opposing ends 114 may rest on the beam support chairs 134 freely or may be welded, bolted, or otherwise coupled to the beam support chairs 134. The beam support chairs 134 may include slots that the opposing ends 114 may be bolted to; such a connection may allow for the support beam 108 to thermally expand when heated and the opposing ends 114 may slide within the slots. In some embodiments, the beam support chairs 134 may point upward and downward, in a mirror-like fashion. The upward and downward orientation of the beam support chairs 134 permits the beam support chairs 134 to support the support beams 108 in varying vertical elevations without the beam support chairs 134 interfering with one another.

Referring now to FIGS. 1 and 3, the support beam 108 may be an I-beam 128. The I-beam 128 includes a top flange 127, a bottom flange 129, and a web 131, such that the top flange 127 and the bottom flange 129 provide resistance against bending or buckling. The I-beam 128 may be made of structural steel, aluminum, or any other suitable material.

The internal structure 106 may span from one side wall 102 to another side wall 102, and may be contoured in shape to the arrangement of the side walls 102. Without use of support beams 108, the internal structure 106 may bend under a weight of the internal structure 106 when spanning the side walls 102, or may not be able to be supported at all with perimeter attachments directly to the side walls 102. Thus, to prevent deformation of the internal structure 106, the support beam 108 supports the internal structure 106. The support beam 108 may support the internal structure 106 in a variety of manners. In some embodiments, the internal structure 106 may rest on the bottom flange 129 between each web 131 of the support beams 108, as depicted in FIG. 3. In other embodiments, the internal structure 106 may rest on the top flange 127, as depicted in FIG. 1. In some embodiments, there may be two or more internal structures 106 supported by the support beam 108, such that the internal structures 106 are positioned along multiple vertical elevations along the z-axis of the support beam 108. The support beam 108 may also function to break up the plurality of fluidized gas bubbles flowing in the vertical direction defined by the z-axis.

Referring again to FIG. 3, the internal structure 106 may rest freely on the bottom flange 129, such that the internal structure 106 may translate horizontally (along the x and y-axes of FIG. 3) or vertically (along the z-axis of FIG. 3). In other embodiments, the internal structure 106 may rest freely on the bottom flange 129, but be restricted from translating vertically by a plurality of hold pins 133. The plurality of hold pins 133 may extend from the web 131, such that the plurality of hold pins 133 are above the internal structure 106 in the direction of the z-axis. The plurality of hold pins 133 may allow some vertical translation of the internal structure 106, such that the plurality of hold pins 133 are not immediately above the internal structure 106. In other embodiments, the plurality of hold pins 133 are immediately above the internal structure 106, such that the internal structure 106 is restricted from any vertical translation. In other embodiments, the internal structure 106 is coupled to the support beam 108 at the bottom flange 129, the web 131, or the top flange 127. In some embodiments, there may be multiple layers of the internal structure 106 on the support beam 108, such that the internal structure 106 may be at the bottom flange 129, the web 131, and the top flange 127. The internal structure 106 may be coupled to the support beam 108 through welding, bolting, or any other suitable coupling means.

The substantially vertical height dimension 110 of the support beam 108 may be uniform throughout the substantially horizontal length dimension 112, as depicted in FIG. 1. In other embodiments, the substantially vertical height dimension 110 of the support beam 108 at a midpoint 122 of the substantially horizontal length dimension 112 is greater than the substantially vertical height dimension 110 of the opposing ends 114 of the support beam 108, as depicted in FIG. 4. The substantially vertical height dimension 110 between the opposing ends 114 and the midpoint 122 may have a uniform slope throughout. In other embodiments, the substantially vertical height dimension 110 between the opposing ends 114 and the midpoint 122 may be convex, such that the vertical height dimension 110 does not have a uniform slope throughout.

Referring again to FIG. 1, the support beam 108 includes the substantially vertical surface portion 116 lying in the plane including the substantially vertical height dimension 110. The plane including the substantially vertical height dimension 110 is defined by the x-z axes in FIG. 1. The substantially vertical surface portion 116 includes the plurality of openings 118 through the width 109 of the support beam 108 (shown in FIG. 3). The plurality of openings 118 define the open area 119 in the substantially vertical surface portion 116. The open area 119 in the substantially vertical surface portion 116 includes from 30% to 95% of the substantially vertical surface portion 116. For example, the open area 119 in the substantially vertical surface portion 116 may comprise from 30% to 35%, from 35% to 40%, from 40% to 45%, from 45% to 50%, from 50% to 55%, from 55% to 60%, from 60% to 65%, from 65% to 70%, from 70% to 75%, from 75% to 80%, from 80% to 85%, from 85% to 90%, from 90% to 95%, or any combination of these ranges, of the substantially vertical surface portion 116 In some embodiments, the open area 119 in the substantially vertical surface portion 116 includes 40% to 85% of the substantially vertical surface portion 116. Without being bound by theory, it is believed that more open space is good for mitigating radial fluid flow reduction, but lesser amounts of open space may be needed to maintain mechanical integrity.

As shown in FIG. 1, in some embodiments, the plurality of openings 118 may be arranged such that the open area 119 in the substantially vertical surface portion 116 includes a lattice beam. The lattice beam may include a plurality of cross-members 124. The plurality of cross-members 124 include the web 131; the plurality of cross-members 124 connect the top flange 127 and the bottom flange 129. The plurality of cross-members 124 in the lattice beam may be vertical (in the z-axis), horizontal, (in the x-axis), or angled at a diagonal. The plurality of cross-members 124 may define various shapes in the plurality of openings 118. For example, in FIG. 4, the plurality of cross-members 124 may alternate in a vertical and diagonal pattern, resulting in triangular openings 118. The plurality of cross-members 124 may also be arranged in other configurations resulting in other shapes in the plurality of openings 118. The plurality of cross-members 124 may also be arranged to include other beam structures, such as an open web beam, trussed beam, or any other suitable beam. Other patterns of open areas 119 are also contemplated herein, such as regular or non-regular spaces punches through the width of the support beam 108.

Absent the plurality of openings 118, normalized fluidization may be prevented in the radial direction (along the x and y axes). The plurality of openings 118 that define the open area 119 in the substantially vertical surface portion 116 encourage mixing of a catalyst through the width 109 of the support beam 108 in the radial direction. The plurality of openings 118 permit the catalyst to flow and/or mix in the radial direction, while the plurality of cross-members 124 provide mechanical support to the support beam 108 and, thus, to the internal structure 106. Radial mixing of the catalyst may increase a gas to solid contact and, thus, increase the rate of reaction between the gas and solid. Radial mixing of the catalyst may also decrease a temperature gradient between the side walls 102. Radial mixing of the catalyst may also provide for uniform temperatures throughout the chemical processing vessel 100.

The chemical processing vessel 100 may further comprise a second support beam 111 in the main interior space 104, or a plurality of support beams 108 in the main interior space 104. The second support beam 111 also supports the internal structure 106. As mentioned hereinabove, the internal structure 106 may be supported in the same manner by the second support beam 111 as with the support beam 108 resting on the bottom flange 129 between the webs 131 or resting on the top flange 127. Any number of support beams 108 are contemplated herein.

The support beam 108 may be at a first substantially vertical elevation 130 and the second support beam 111 may be at a second substantially vertical elevation 132. The first substantially vertical elevation 130 and the second substantially vertical elevation 132 are at different vertical elevations (different points along the z-axis). The first substantially vertical elevation 130 and the second substantially vertical elevation 132 may be spaced at various vertical elevations, such as from 2 feet to 6 feet apart. In some embodiments, the shorter the substantially horizontal length dimension 112 between the opposing ends 114 of the support beam 108 and the second support beam 111, the less the first substantially vertical elevation 130 and the second substantially vertical elevation 132 are spaced. In other embodiments, the plurality of support beams 108 may be positioned at a plurality of substantially vertical elevations.

The support beam 108 and the second support beam 111 may be substantially parallel, such that the support beam 108 and the second support beam 111 are equidistant to one another throughout the substantially horizontal length dimension 112 or the substantially vertical height dimension 110. The plurality of openings 118 of the support beam 108 and the second support beam 111 may be aligned. In other embodiments, the support beam 108 at the first substantially vertical elevation 130 is not substantially parallel to the second support beam 111 at the second substantially vertical elevation 132. In embodiments where the support beam 108 and the second support beam 111 are not substantially parallel, the support beam 108 and the second support beam 111 may be at an angle ranging from 30 degrees to 150 degrees from one another in the horizontal plane defined by the x-y axes of FIG. 3.

Referring to FIG. 3, the support beam 108 and the second support beam 111 may be coupled by a mechanical constraint 126. The mechanical constraint 126 may also couple the plurality of support beams 108. The mechanical constraint 126 may couple the plurality of support beams 108 on the first substantially vertical elevation 130, the plurality of support beams 108 at the second substantially vertical elevation 132, or the plurality of support beams 108 on the first substantially vertical elevation 130 to the plurality of support beams 108 on the second substantially vertical elevation 132. In some embodiments, the mechanical constraint 126 may mechanically couple the support beams 108 through welding, bolting, or any other suitable fasteners. However, such embodiments may result in buckling of the support beams 108 upon thermal expansion of the mechanical constraint 126. As such, the mechanical constraint 126 may couple to the support beams 108 through a slide joint, such that the mechanical constraint 126 may slide along the support beams 108 and avoid buckling upon thermal expansion of the mechanical constraint 126. In embodiments, the mechanical constraint 126 offers structural support to the support beams 108 to prevent the support beams 108 from overturning or buckling. The mechanical constraint 126 also maintains alignment of the plurality of openings 118 between substantially parallel support beams 108 when the plurality of support beams 108 are heated.

In some embodiments, the plurality of support beams 108 may include an aperture, such that the mechanical constraint 126 extends through the aperture and slidably couples to the plurality of support beams 108. The mechanical constraint 126 may include a steel cable, an I-beam, or any other suitable mechanical constraint.

Additional embodiments disclosed herein are directed to methods for chemical processing which utilize the chemical processing vessels presently disclosed. The methods may include contacting a reactant with fluidized particles in the chemical processing vessel. As described herein, the fluidized particles may comprise a fluidized bed flow regime.

In one or more embodiments, based on the shape, size, flows of gases, and other processing conditions (such as temperature and pressure) in chemical processing vessel 100, the chemical processing vessel 100 may operate as a fluidized bed, referred to herein as a fluidized bed flow regime. As is understood by those in the art, fluidized bed flow regime generally occurs when a solid particulate substance is under the right conditions so that it behaves like a fluid. The usual way to achieve a fluidized bed is to pump pressurized fluid into the particles. According to various embodiments, the fluidized bed regime may be classified as a fast fluidized, turbulent, or bubbling bed fluidization. As described herein, a “fast fluidized” reactor may refer to a reactor utilizing a fluidization regime wherein the superficial velocity of the gas phase is greater than the choking velocity and may be semi-dense in operation. As described herein, a “turbulent” reactor may refer to a fluidization regime where the superficial velocity of less than the choking velocity and is more dense than the fast fluidized regime. As described herein, a “bubbling bed” reactor may refer to a fluidization regime wherein well defined bubbles in a highly dense bed are present in two distinct phases. The “choking velocity” refers to the minimum velocity required to maintain solids in the dilute-phase mode in a vertical conveying line.

According to embodiments, the fluidized particles may pass through the open area 119 in the substantially vertical surface portion 116 of the support team 108. As described herein, the existence of the open area 119 may mitigate mal-distribution and mal-flow of the fluidized particles.

It is contemplated herein that the fluidized particulates may be solid catalysts or non-catalytic solids such as, for example, materials capable of carrying oxygen. In non-limiting examples, the chemical processing vessel 100 described herein may be utilized to produce light olefins from hydrocarbon feed streams. Light olefins may be produced from a variety of hydrocarbon feed streams by utilizing different reaction mechanisms. For example, light olefins may be produced by at least dehydrogenation reactions, cracking reactions, dehydration reactions, and methanol-to-olefin reactions. These reaction types may utilize different feed streams and different catalytic particulate solids to produce light olefins.

In some embodiments, the fluidized particulates may exhibit properties known in the industry as “Geldart A” or “Geldart B” properties. Particles may be classified as “Group A” or “Group B” according to D. Geldart, Gas Fluidization Technology, John Wiley & Sons (New York, 1986), 34-37; and D. Geldart, “Types of Gas Fluidization,” Powder Technol. 7 (1973) 285-292, which are incorporated herein by reference in their entireties.

Group A is understood by those skilled in the art as representing an aeratable powder, having a bubble-free range of fluidization; a high bed expansion; a slow and linear deaeration rate; bubble properties that may include a predominance of splitting/recoalescing bubbles, with a maximum bubble size and large wake; high levels of solids mixing and gas backmixing, assuming equal U-Umf (U is the velocity of the carrier gas, and Umf is the minimum fluidization velocity, typically though not necessarily measured in meters per second, m/s, i.e., there is excess gas velocity); axisymmetric slug properties; and no spouting, except in very shallow beds. The properties listed tend to improve as the mean particle size decreases, assuming equal particle size (cfp); or as the <45 micrometers (μm) proportion is increased; or as pressure, temperature, viscosity, and density of the gas increase. In general, the particles may exhibit a small mean particle size and/or low particle density (<1.4 grams per cubic centimeter, g/cm³), fluidize easily, with smooth fluidization at low gas velocities, and may exhibit controlled bubbling with small bubbles at higher gas velocities.

Group B is understood by those skilled in the art as representing a “sand-like” powder that starts bubbling at Umf; that exhibits moderate bed expansion; a fast deaeration; no limits on bubble size; moderate levels of solids mixing and gas backmixing, assuming equal U-Umf; both axisymmetric and asymmetric slugs; and spouting in only shallow beds. These properties tend to improve as mean particle size decreases, but particle size distribution and, with some uncertainty, pressure, temperature, viscosity, or density of gas seem to do little to improve them. In general, most of the particles having a particle size (cfp) of 40 μm<cfp<500 μm when the density (pp) is 1.4<pp<4 g/cm³, and 60 μm<cfp<500 μm when the density (pp) is 4 g/cm³ and 250 μm<cfp<100 μm when the density (pp) is 1 g/cm³.

The present disclosure includes several aspects. According to a first aspect of the present disclosure a chemical processing vessel comprises side walls defining a main interior space; an internal structure positioned within the main interior space; a support beam positioned within the main interior space and comprising a substantially vertical height dimension and a substantially horizontal length dimension, wherein: opposing ends of the support beam in the substantially horizontal length dimension are each positioned at or near the side walls; the support beam supports the internal structure; the support beam comprises a substantially vertical surface portion lying in a plane comprising the substantially vertical height dimension; the substantially vertical surface portion comprises a plurality of openings through a width of the support beam defining an open area in the substantially vertical surface portion; and the open area in the substantially vertical surface portion comprises from 30% to 95% of the substantially vertical surface portion.

A second aspect of the present disclosure may include the first aspect, wherein the open area in the substantially vertical surface portion comprises from 40% to 85% of the substantially vertical surface portion.

A third aspect of the present disclosure may include any previous aspect or combination of aspects, wherein the internal structure comprises a grating tray.

A fourth aspect of the present disclosure may include any previous aspect or combination of aspects, wherein the substantially vertical height dimension of the support beam at a midpoint of the substantially horizontal length dimension is greater than the substantially vertical height dimension of the opposing ends of the support beam.

A fifth aspect of the present disclosure may include any previous aspect or combination of aspects, wherein the support beam comprises a lattice beam.

A sixth aspect of the present disclosure may include any previous aspect or combination of aspects, further comprising a second support beam positioned within the main interior space, wherein the second support beam supports the internal structure.

A seventh aspect of the present disclosure may include the sixth aspect, wherein the support beam and the second support beam are coupled by a mechanical constraint.

An eighth aspect of the present disclosure may include the sixth aspect, the seventh aspect, or a combination thereof, wherein the support beam and the second support beam are substantially parallel.

A ninth aspect of the present disclosure may include any of the sixth through eighth aspects, wherein the support beam is at a first substantially vertical elevation and the second support beam is at a second substantially vertical elevation, wherein the first substantially vertical elevation and second substantially vertical elevation are at different vertical elevations.

A tenth aspect of the present disclosure may include the ninth aspect, wherein the support beam at the first substantially vertical elevation is not substantially parallel with respect to the second support beam at the second substantially vertical elevation.

An eleventh aspect of the present disclosure may include a method for chemical processing, the method comprising: contacting a reactant with fluidized particles in the chemical processing vessel of any of any previous aspect, wherein the fluidized particles comprise a fluidized bed flow regime.

A twelfth aspect of the present disclosure may include the eleventh aspect, wherein the fluidized bed flow regime is chosen from fast fluidized flow, turbulent flow, or bubbling bed fluidization.

A thirteenth aspect of the present disclosure may include the eleventh aspect, the twelfth aspect, or a combination thereof, wherein the fluidized particles pass through the open area in the substantially vertical surface portion of the support beam.

A fourteenth aspect of the present disclosure may include any of the eleventh through thirteenth aspects, wherein the fluidized particles are catalysts.

A fifteenth aspect of the present disclosure may include any of the eleventh through fourteenth aspects, wherein the fluidized particles are classified as Geldart A or Geldart B.

The subject matter of the present disclosure has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

1. A chemical processing vessel comprising:
side walls defining a main interior space;
an internal structure positioned within the main interior space;
a support beam positioned within the main interior space and comprising a substantially vertical height dimension and a substantially horizontal length dimension, wherein:
opposing ends of the support beam in the substantially horizontal length dimension are each positioned at or near the side walls;
the support beam supports the internal structure;
the support beam comprises a substantially vertical surface portion lying in a plane comprising the substantially vertical height dimension;
the substantially vertical surface portion comprises a plurality of openings through a width of the support beam defining an open area in the substantially vertical surface portion; and
the open area in the substantially vertical surface portion comprises from 30% to 95% of the substantially vertical surface portion.

2. The chemical processing vessel of claim 1, wherein the open area in the substantially vertical surface portion comprises from 40% to 85% of the substantially vertical surface portion.

3. The chemical processing vessel of claim 1, wherein the internal structure comprises a grating tray.

4. The chemical processing vessel of claim 1, wherein the substantially vertical height dimension of the support beam at a midpoint of the substantially horizontal length dimension is greater than the substantially vertical height dimension of the opposing ends of the support beam.

5. The chemical processing vessel of claim 1, wherein the support beam comprises a lattice beam.

6. The chemical processing vessel of claim 1, further comprising a second support beam positioned within the main interior space, wherein the second support beam supports the internal structure.

7. The chemical processing vessel of claim 6, wherein the support beam and the second support beam are coupled by a mechanical constraint.

8. The chemical processing vessel of claim 6, wherein the support beam and the second support beam are substantially parallel.

9. The chemical processing vessel of claim 6, wherein the support beam is at a first substantially vertical elevation and the second support beam is at a second substantially vertical elevation, wherein the first substantially vertical elevation and second substantially vertical elevation are at different vertical elevations.

10. The chemical processing vessel of claim 9, wherein the support beam at the first substantially vertical elevation is not substantially parallel with respect to the second support beam at the second substantially vertical elevation.

11. A method for chemical processing, the method comprising:
contacting a reactant with fluidized particles in the chemical processing vessel of claim 1, wherein the fluidized particles comprise a fluidized bed flow regime.

12. The method of claim 11, wherein the fluidized bed flow regime is chosen from fast fluidized flow, turbulent flow, or bubbling bed fluidization.

13. The method of claim 11, wherein the fluidized particles pass through the open area in the substantially vertical surface portion of the support beam.

14. The method of claim 11, wherein the fluidized particles are catalysts.

15. The method of claim 11, wherein the fluidized particles are classified as Geldart A or Geldart B.
